(19) United States
(12) Patent Application Publication
(10) Pub. No.: US 2024/0397957 A1
(43) Pub. Date: Dec. 5, 2024

(54) APPARATUS AND SYSTEM FOR PRODUCING LAYERED FOOD PRODUCTS

(71) Applicant: Abdurrahman Atique Khalidi, Laurel, MD (US)

(72) Inventor: Abdurrahman Atique Khalidi, Laurel, MD (US)

(21) Appl. No.: 18/205,658

(22) Filed: Jun. 5, 2023

(51) Int. Cl. A21C 3/02; A21C 9/04

(52) U.S. Cl. CPC A21C 3/022; A21C 9/045

(57) ABSTRACT

A system for producing a layered food product includes a frame, a plurality of molding units, a plank, a conveyor belt, and a collection bin. The plurality of molding units are configured to apply pressure to a plurality of food layers and each include an apparatus and a spring. An external surface of the body includes a plurality of external, upper walls connecting to form a pyramid. The internal surface includes a plurality of internal, upper walls that have a first lining configured to shape the plurality of food layers and a second lining configured to seal the plurality of food layers, and a plurality of internal, lower walls that terminate in a geometric edge configured to cut the plurality of food layers. The spring is operably connected to the apparatus and configured to move a molding unit into an active position and a retracted position.

### TECHNICAL FIELD

The present disclosure relates generally to an apparatus and system for food production, and more particularly, to an apparatus and system for preparation and production of layered food products.

### BACKGROUND

Layered food products include a wide variety of cuisine, such as pastries, croissants, breads, cakes, and various other items. These food products often involve a process known as lamination, which requires the overlap of numerous alternating layers of dough and fat prior to baking. These layers can separate and rise during baking, resulting in expansion of the resulting food product, as is typically seen in a croissant. At times, these food products also include a filling. When lamination is combined with filling, additional shaping, sealing, and cutting procedures are often required, which necessitate extra effort and care to complete the food products.

Often, it can become cumbersome to produce large quantities of laminated dough food products using existing appliances. The effort needed is compounded when large scale production is required, leading to increased time and effort, which can decrease quality in output.

Accordingly, there exists a need for improvements in production of layered food products.

### SUMMARY

In accordance with aspects of the present disclosure, an apparatus for producing a layered food product includes a handle assembly and a body. The handle assembly is configured to apply pressure to a plurality of food layers. The handle assembly includes a rod configured for grasping by a user and a crossbar operably connected to the rod. The body is configured to move relative to the handle assembly. The body of the apparatus includes an external surface and an internal surface. The external surface includes a plurality of external, upper walls and a plurality of external, lower walls. The plurality of external, upper walls taper to an uppermost surface and connect to form a pyramid, so the uppermost surface maintains contact with the crossbar. The internal surface includes a plurality of internal, upper walls and a plurality of internal, lower walls. The plurality of internal, upper walls have a first lining configured to shape the plurality of food layers, and a second lining configured to seal the plurality of food layers. The plurality of internal, lower walls terminate in a geometric edge configured to cut the plurality of food layers in a shape corresponding to the geometric edge.

In an aspect of the present disclosure, applying pressure to the handle assembly may enable the body to: shape the plurality of food layers into a pyramid; seal the plurality of food layers; and cut the plurality of food layers to produce the layered food product. Sealing the plurality of food layers may include sealing a filling inside of the layered food product.

In another aspect of the present disclosure, the plurality of food layers may include at least two layers of laminated dough.

In yet another aspect of the present disclosure, at least one of the handle assembly and the body may be fabricated from stainless steel.

In a further aspect of the present disclosure, the rod may include a grip.

In yet a further aspect of the present disclosure, the handle assembly may be attached to the external, upper walls in a fixed manner. The handle assembly may be attached to the external, upper walls by at least one of welding, crimping, gluing, or fastening.

In an aspect of the present disclosure, the plurality of external, lower walls may each have a length ranging from about 8.5 centimeters to 10.5 centimeters.

In another aspect of the present disclosure, the plurality of external, lower walls may each have a height ranging from about 0.5 centimeters to 2.5 centimeters.

In accordance with aspects of the present disclosure, a system for producing a layered food product includes a frame, a plurality of molding units, a plank, a conveyor belt, and a collection bin. The frame is configured to support the system and includes a plurality of vertical support shafts, a rod, and a base. The plurality of molding units are configured to apply pressure to a plurality of food layers, and each of the plurality of molding units includes an apparatus and a spring. A body of the apparatus includes an external surface and an internal surface. The external surface includes a plurality of external, upper walls and a plurality of external, lower walls. The plurality of external, upper walls taper at an uppermost point and connect to form a pyramid. The internal surface includes a plurality of internal, upper walls and a plurality of internal, lower walls. The plurality of internal, upper walls have a first lining configured to shape the plurality of food layers, and a second lining configured to seal the plurality of food layers. The plurality of internal, lower walls terminate in a geometric edge configured to cut the plurality of food layers. The spring is operably connected to the apparatus and configured to move a molding unit of the plurality of molding units into an active position and a retracted position. The plank operably connects the spring to the apparatus and is configured to apply pressure to the apparatus. The conveyor belt is configured to transport the plurality of food layers and the layered food product. The collection bin is configured to store the layered food product.

In an aspect of the present disclosure, the system may further include a processor and a memory. The memory may have instructions stored thereon that, when executed, cause the system to: extend the spring along a downward plane; apply pressure from the spring to the plank; and apply pressure from the plank to the apparatus, causing the molding unit of the plurality of molding units to convert from the open position to the closed position. The open position may enable the apparatus to: shape the plurality of food layers into a pyramid; seal the plurality of food layers; and cut the plurality of food layers, producing the layered food product. Sealing the plurality of food layers may include sealing a filling inside of the layered food product.

In another aspect of the present disclosure, at least one of the frame, the plurality of molding units, and the plank are fabricated from stainless steel.

In yet another aspect of the present disclosure, the instructions may further cause the system to convert the conveyor belt from an active state to a paused state. In the active state, the conveyor belt may engage in motion at a predetermined speed. The predetermined speed may be between about 2.5 centimeters to 7.6 centimeters per minute. In the paused state, the conveyor belt may cease motion for a predetermined length of time. The predetermined length of time may be between about 2 to 4 minutes.

In accordance with aspects of the present disclosure, an apparatus for producing a layered food product includes a handle assembly and a body. The handle assembly is configured to apply pressure to a plurality of food layers. The handle assembly includes a U-shaped rod configured for grasping by a user and a crossbar operably connected to the rod. The body is configured to move relative to the handle assembly. The body of the apparatus includes an external surface and an internal surface. The external surface includes a plurality of external, upper walls and a plurality of external, lower walls. The plurality of external, upper walls taper at a peak and connect to form a pyramid, so the peak maintains contact with the crossbar, and the plurality of external, lower walls form sloped sides. The internal surface includes a plurality of internal, upper walls and a plurality of internal, lower walls. The plurality of internal, upper walls have a first lining configured to shape the plurality of food layers, and a second lining configured to seal the plurality of food layers. The plurality of internal, lower walls terminate in a square edge configured to cut the plurality of food layers. Applying pressure to the handle assembly enables the body to: shape the plurality of food layers into a pyramid; seal the plurality of food layers; and cut the plurality of food layers, producing the layered food product

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1A is front, perspective view of an apparatus for producing a layered food product in accordance with the present disclosure;

FIGS. 1B and 1C are side, perspective views of the apparatus of FIG. 1A.

FIG. 2 is a bottom, perspective view of the apparatus of FIGS. 1A, 1B, and 1C;

FIG. 3 is layered food product produced using the apparatus of FIGS. 1A, 1B, 1C and 2;

FIGS. 4A and 4B are front views of a system for producing a layered food product in an open and closed position, respectively, in accordance with the present disclosure;

FIG. 5 is a block diagram of a controller configured for use with the system of FIGS. 4A and 4B; and

FIGS. 6A and 6B are an exemplary illustration of creation of the layered food product of FIG. 3 using the apparatus of FIGS. 1A, 1B, 1C and 2.

### DETAILED DESCRIPTION

Aspects of the present disclosure are described in detail with reference to the drawings wherein like reference numerals identify similar or identical elements.

The phrases “in an aspect,” “in aspects,” “in various aspects,” “in some aspects,” or “in other aspects” may each refer to one or more of the same or different aspects in accordance with the present disclosure.

Although the present disclosure will be described in terms of specific aspects, it will be readily apparent to those skilled in this art that various modifications, rearrangements, and substitutions may be made without departing from the spirit of the present disclosure. The scope of the present disclosure is defined by the claims appended hereto. For purposes of promoting an understanding of the principles of the present disclosure, reference will now be made to exemplary aspects illustrated in the drawings, and specific language will be used to describe the same.

The present disclosure relates to an apparatus and system for the preparation and production of layered food products. While the use of dough is mentioned, various alternative materials are contemplated. As described in further detail below, because all components necessary to produce the layered food products are included within a single apparatus, production may be completed with a single action.

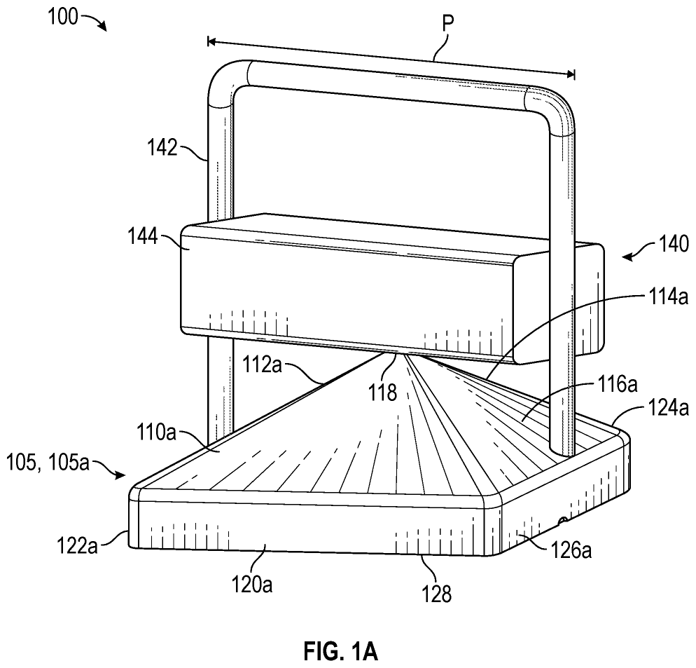

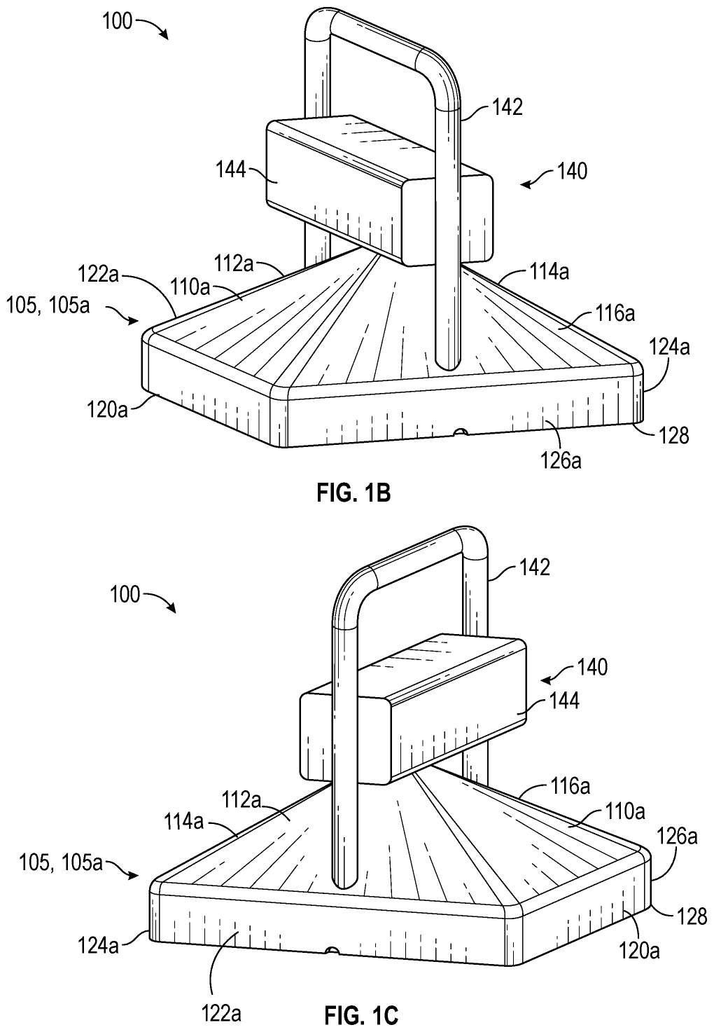

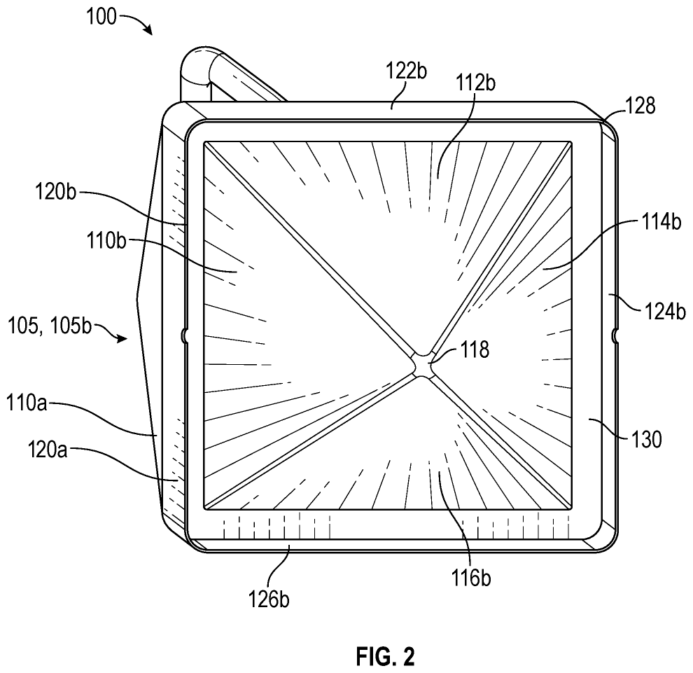

Referring now to FIGS. 1A, 1B, 1C, and 2, a layered food production apparatus 100 is shown. Apparatus 100 is configured to produce a layered food product, such as food product 300. Apparatus 100 includes a body and an interior/exterior housing, such as body 105 having exterior housing 105a (FIGS. 1A, 1B, 1C) and interior housing 105b (FIG. 2). Body 105 may be fabricated from metal, plastic, composite material, and/or any other suitable material. Generally, body 105 is fabricated from stainless steel, which provides rigidity and a high resistance to heat and rust. Body 105 may be treated with a non-stick coating such as Teflon® or polytetrafluoroethylene (PTFE), and/or a scratch/rust-resistant coating such as zinc or epoxy.

With reference to FIGS. 1A, 1B, and 1C, exterior housing 105a includes exterior, upper walls 110a, 112a, 114a, 116a, and exterior, lower walls 120aa, 122, 124a, 126a. The exterior, upper walls 110a, 112a, 114a, 116a each extend upward, tapering off and connecting at a central point 118 (e.g., an uppermost point). The exterior, upper walls 110a, 112a, 114a, 116a may each have a triangular shape and connect to form a pyramid, although alternative shapes are contemplated. The exterior, lower walls 120a, 122, 124a, 126a may each have a rectangular shape and connect to form a square with rounded edges, although alternative shapes are contemplated. The exterior, lower walls 120a, 122, 124a, 126a may have a height ranging from 0.5 cm to 2.5 cm, and a length ranging from 8.5 to 10.5 cm, although alternative sizes may be used. For example, exterior, lower walls 120a, 122, 124a, 126a may be approximately 1.5 cm in height, and approximately 9.5 centimeters in length.

Generally, the exterior, upper walls 110a, 112a, 114a, 116a may each maintain a similar shape and size, and likewise, the exterior, lower walls 120aa, 122, 124a, 126a may each maintain a similar shape and size, although varying combinations of shapes and sizes may be implemented. Each of the exterior, lower walls 120a, 122a, 124a, 126a extends downward from the exterior, upper walls 110a, 112a, 114a, 116a to form sloped sides of the body 105 that end in an edge 128. Generally, the shape of edge 128 is determined by the configuration of the exterior, lower walls 120a, 122a, 124a, 126a (e.g., a square with rounded edges), although various alternative shapes may be employed if suitable. Therefore, generally, the sides of edge 128 have the same length as exterior, lower walls 120a, 122, 124a, 126a (e.g., sides each ranging from about 8.5 cm to 10.5 cm in length), although alternative sizes are contemplated. For example, each side of edge 128 may be 9.5 cm in length.

Exterior, upper walls 110a, 112a, 114a, 116a and exterior, lower walls 120a, 122a, 124a, 126a may be formed from a single component, or may be coupled together by welding, crimping, gluing, fastening (not shown), or any other suitable method. While eight walls are pictured, any number or arrangement of walls may be used. In aspects, exterior, upper walls 110a, 112a, 114a, 116a and exterior, lower walls 120a, 122a, 124a, 126a can individually have and/or join to create alternative shapes such as other squares, rectangles, circles, or any other suitable shape.

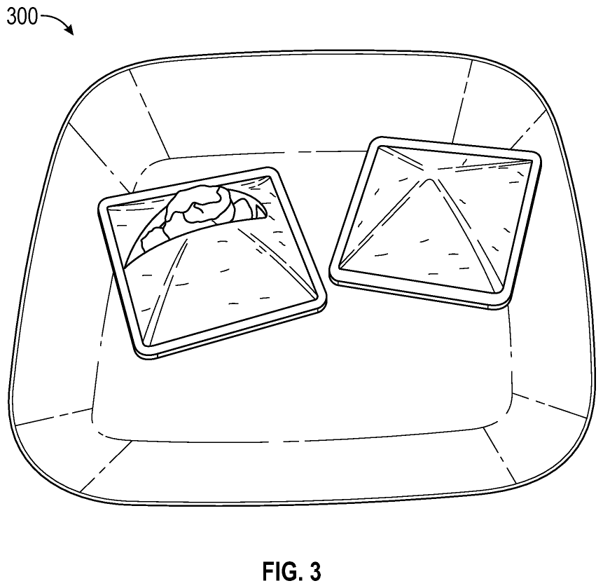

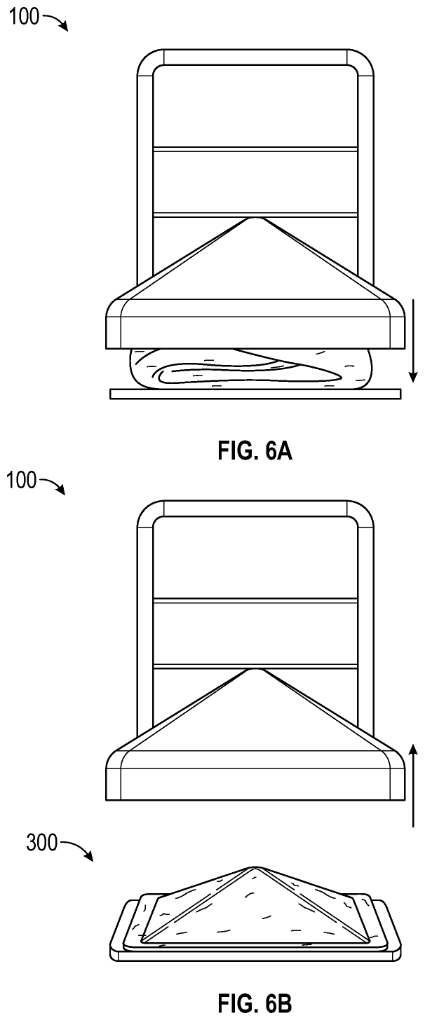

With further reference to FIGS. 1A, 1B, and 1C, body 105 may include handle assembly 140 to enable apparatus 100 for use as a handheld device. Handle assembly 140 includes rod 142 and crossbar 144. In use, handle assembly 140 is configured to apply pressure to body 105, allowing body 105 to shape, seal, and/or cut material (e.g., one or more layers of dough) into a food product 300 (FIGS. 3, 6A, 6B). Rod 142 enables a user to grip handle assembly 140. Rod 142 may have a U shape that supports ease of gripping, although various alternative shapes may be employed, such as shapes that are more ergonomically friendly for the user (e.g., shaped to fit the user's hand). In aspects, rod 142 may include a grip (not shown), such as a rubber lining or embossed texture to prevent slippage, such as slippage of the user's hand. Rod 142 generally has a circular cross section, although alternative cross-sectional shapes may be employed. Similar to body 105, rod 142 may be fabricated from stainless steel, although various metals, plastics, composite materials, and/or other alternative material are contemplated.

Rod 142 connects to body 105, which enables pressure exerted on handle assembly 140 (including rod 142) to be transferred to body 105, and subsequently to the material for food product 300. Rod 142 may be coupled to body 105 in a fixed manner, such as welding, crimping, gluing, or fastening, or another suitable method. In aspects, rod 142 may be removably coupled to body 105 using a plurality of notches, pins, fasteners (not shown), or another suitable method. Crossbar 144 is coupled to rod 142 and is also configured to exert pressure on body 105. A length of crossbar 144 may define a plane P, where pressure is exerted on handle assembly 140 in a direction perpendicular to plane P. As shown in FIGS. 1A, 1B, and 1C, crossbar 144 may be connected with at least two sides of rod 142. Crossbar 144 may have a square-shaped cross section, although alternative shapes are contemplated. Crossbar 144 may also be fabricated from stainless steel, although various metals, plastics, composite materials, or other alternative materials may be included. Both rod 142 and body 105 may connect with crossbar 144. Similar to rod 142, crossbar 144 may be coupled to body 105 and/or rod 142 in a fixed manner, or may be removably attached to body 105 and/or rod 142. In aspects, crossbar 144 may include pins and biased springs (not shown), which permit vertical and/or horizontal motion of crossbar 144. Crossbar 144 and body 105 may connect at central point 118, which may transfer pressure from handle assembly 140 to a center of gravity of body 105, applying an even distribution of pressure to body 105 and subsequently to the material of food product 300. In aspects, a user may grip handle assembly 140 via crossbar 144, applying initial pressure from a point closer in space to the material of food product 300, which may be easier and/or preferable for certain users as less pressure may be required.

With reference to FIG. 2, interior housing 105b includes interior, upper walls 110b, 112b, 114b, 116b, interior, lower walls 120b, 122b, 124b, 126b, and lining 130. Interior, upper walls 110b, 112b, 114b, 116b and interior, lower walls 120b, 122b, 124b, 126b generally oppose exterior, upper walls 110a, 112a, 114a, 116a, and exterior, lower walls 120aa, 122, 124a, 126a, respectively, and thus may maintain similar features.

Each of interior, upper walls 110b, 112b, 114b, 116b, interior, lower walls 120b, 122b, 124b, 126b, and/or lining 130 may make contact with the material (e.g., the layers of dough) of food product 300 during production thereof. Interior, upper walls 110b, 112b, 114b, 116b (i.e., a “first lining”) are configured to shape and/or mold the material of food product 300 into an intended shape by applying pressure thereto. Generally, the resulting food product 300 will mimic the shape of interior, upper walls 110b, 112b, 114b, 116b. For example, as seen in FIG. 2, interior, upper walls 110b, 112b, 114b, 116b each have a triangular shape and, together, form a pyramid. By pressing the material into interior, upper walls 110b, 112b, 114b, 116b, food product 300 may also contain four triangular walls, forming a pyramid (FIGS. 3, 6A, 6B).

Lining 130 (i.e., a “second lining”) is configured to seal together and/or flatten layers of the material of food product 300 (e.g., sealing together two layers of dough) when pressure is applied to lining 130. Lining 130 may be between about 0.2 cm to 0.4 cm above edge edge 128, although other dimensions are contemplated. Generally, the resulting food product 300 will have a border that mimics the shape of lining 130. For example, where lining 130 has a flat, square shape, food product 300 will contain a flat, square-shaped border (FIGS. 3, 6A, 6B). Where a food product 300 with a filling is used, lining 130 also functions to retain the filling within the material of food product 300 during. For example, by sealing two sides of dough together, lining 130 may prevent the filling from exiting food product 300. As shown in FIG. 3, after being sealed, the food product may later be sliced open (e.g., in consumption) to reveal the internal filling (shown for illustration purposes).

Interior, lower walls 120b, 122b, 124b, 126b are configured to cut out food product 300 from excess material via edge 128 when pressure is applied to edge 128. For example, interior, lower walls 120b, 122b, 124b, 126b may press down on the material (e.g., the layers of dough), exerting sufficient pressure to enable edge 128 to cut through the material and release food product 300. Generally, food product 300 will have a perimeter that mimics the shape of edge 128. For example, when edge 128 has a square shape with rounded edges, food product 300 may have a perimeter that exhibits a square shape with rounded edges.

While eight walls are pictured, and suitable number and/or arrangement of walls are contemplated. In aspects, interior, lower walls 120b, 122b, 124b, 126b, exterior, upper walls 110b, 112b, 114b, 116b, and/or lining 130 may individually have and/or join to create alternative shapes such as other squares, rectangles, circles, or any other suitable shape. Moreover, while pictured as smooth, flat surfaces, each of interior, lower walls 120b, 122b, 124b, 126b, exterior, upper walls 110b, 112b, 114b, 116b, and/or lining 130 may contain embossments or other texturized features to impart on the resulting food product 300. For example, the interior, upper walls 110b, 112b, 114b, 146b may contain striations, which may be impressed upon a top layer of the material (e.g., dough), adding striations to food product 300.

Because all components necessary to produce food product 300 (e.g., shaping, sealing, and cutting) are included within the apparatus 100, production of food product 300 may be completed using a single action/motion by a user or entity. For example, by applying pressure to handle assembly 140, pressure may be transferred to body 105, causing: shaping by interior, upper walls 110b, 112b, 114b, and 116b; sealing by lining 130; and cutting by edge 128, resulting in food product 300. Thereafter, food product 300 may be stored for later use (e.g., refrigeration due to raw dough, which requires a cool space) and/or prepared (e.g., cooked) into a final product for consumption (not shown).

The material used may be laminated dough, such as thin layers of alternating dough and fat, which can rise while baking. In aspects, the dough may be pre-cut sheets, which may permit use in both personal and large-scale formats (as discussed below). The pre-cut sheets of dough may be sized based on the size of apparatus 100. For example, two pre-cut sheets of dough may be placed together and overlap neatly to form food product 300 without additional re-shaping, re-sealing, re-cutting etc., therefore eliminating the waste of valuable dough. As an illustrative example, two 10×10 cm square sheets of filo dough may be obtained. A filling (e.g., 25 to 30 grams) may be placed into the middle of a first sheet of filo dough, which may then be fully covered with a second sheet of filo dough and then shaped, sealed, and cut to obtain food product 300 in a single execution (FIGS. 6A, 6B).

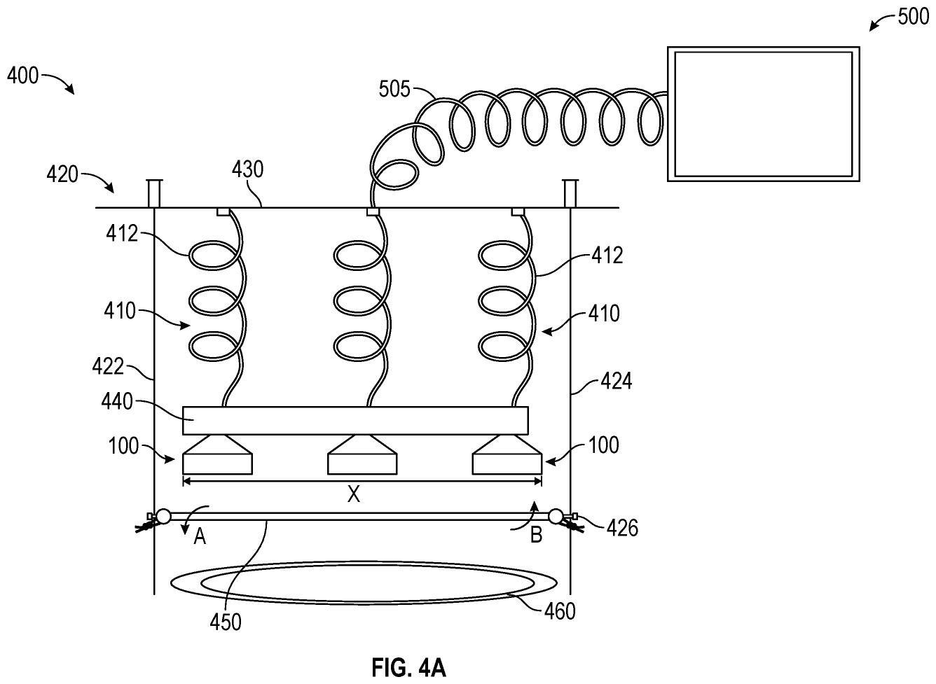

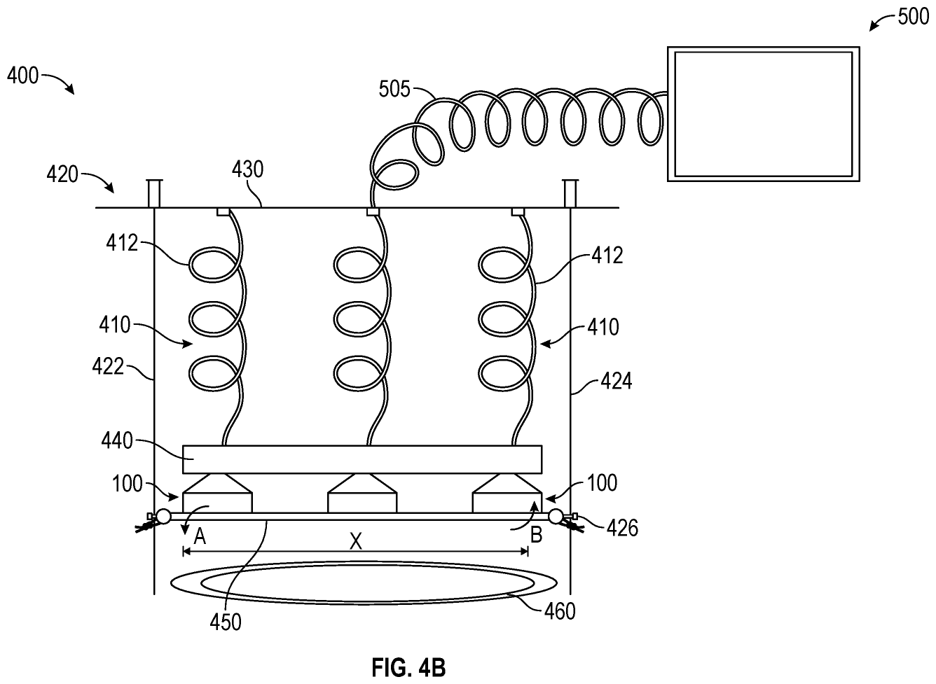

FIGS. 4A and 4B illustrates a mass production system 400 for use with apparatus 100, which creates food product 300. System 400 includes molding units 410, frame 420, plank 440, conveyor belt 450, collection bin 460, and/or controller 500.

Frame 420 includes vertical support shafts 422, 424, base 426 and rod 430. Rod 430 is configured to support at least one of the molding units 410. Vertical support shafts 422, 424 are configured to detachably couple to and support base 426 and rod 430. While two vertical support shafts 422, 424 are shown, any number of shafts may be used. Base 426 is configured to support conveyor belt 450 and food product 300. In aspects, base 426 may have a planar, rectangular, or square shape and/or cross section, although other shapes are contemplated. Vertical support shafts 422, 424, base 426, and rod 430 may be fabricated from stainless steel, although various metals, plastics, composite materials, and/or other alternative materials may be used, which may provide additional weight, strength and/or rigidity.

Plank 440 is configured to apply pressure to apparatus 100. Plank 440 may have a planar, rectangular, or square shape and/or cross section, although other suitable shapes are contemplated. Similar to rod 142, plank 440 may be fabricated from stainless steel, although various metals, plastics, composite materials, or other alternative material may be used, which may provide additional weight, strength and/or rigidity.

Conveyor belt 450 is configured to transport the resulting food product 300. In aspects, conveyor belt 450 may be a power-driven belt line. Generally, conveyor belt 450 is made from plastics and/or composite materials, although other suitable materials may be used. Conveyor belt 450 may be directed by a controller 500, such as a programmable logic controller (“PLC”). In aspects, conveyor belt 450 may be directed by controller 500 to operate in various states. For example, in an active state, controller 500 may direct conveyor belt 450 to move in direction A at a predetermined (e.g., programmed) speed. Direction A may be a direction perpendicular to a plane X defined by a length of plank 440. Conveyor belt may also move in opposing direction B, which is similarly perpendicular to plane X. The predetermined speed may have a range between about 2.5 cm to 7.6 cm per minute, although other rates are contemplated. For example, the predetermined speed may be approximately 5.1 cm per minute. Controller 500 may direct conveyor belt 450 to enter a paused state, causing conveyor belt 450 to cease movement for a programmed length of time. The predetermined length of time may range from about 2 to 4 minutes, although other lengths of time may be used. For example, the predetermined length of time may be 3 minutes. Therefore, for example, the total movement of the conveyor belt may be approximately 15.2 centimeters every 3 minutes, although other ranges of movement are contemplated.

Molding units 410 may each contain apparatus 100 and spring 412. Similar to FIGS. 1A, 1B, 1C, and 2, apparatus 100 includes body 105, having exterior surface 105a and interior surface 105b with similar aspects and features disclosed in FIGS. 1A, 1B, 1C and 2 as stated herein. However, unlike FIGS. 1A, 1B, 1C, and 2, apparatus 100 in FIGS. 4A and 4B may not contain handle assembly 140. Alternatively, apparatus 100 may be coupled to spring 412 by plank 440. Spring 412 may be connected to both rod 430 and plank 440. Spring 412 may be fabricated from metal, rubber, composites, or any other suitable material, which may offer additional strength, rigidity and/or resilience. In aspects, instead of spring 412, another device such as a rod or arm (not pictured) is contemplated.

In use, spring 412 is configured to direct a molding unit 410 to extend (i.e., an “closed position”) and retract (i.e., a “open position”). Spring 412 may be directed by controller 500 to trigger the closed position and/or open position of molding unit 410. The open position is generally the default state of molding unit 410 (FIG. 4A). In the open position, spring 412 is retracted upwards towards rod 430, suspending plank 440 and apparatus 100 above conveyor belt 450 to avoid contact with the material of food product 300. In aspects, molding unit 410 maintains the open position when conveyor belt 450 is in the active state, which allows materials and food products 300 to move along conveyor belt 450 without interference by apparatus 100 or other system components. Food products 300 may be transported along conveyor belt 450 into collection bin 460 for subsequent storage and/or use. In the closed position (FIG. 4B), spring 412 is extended downwards towards conveyor belt 450, applying pressure to plank 440, transferring pressure by plank 440 to apparatus 100, and subsequently transferring pressure by plank 440 to the material of food product 300 (e.g., the layers of dough) and conveyor belt 450, creating food product 300. In aspects, molding unit 410 maintains the closed position when conveyor belt 450 is in the paused state, allowing sufficient time to exert pressure on the material of food product 300 to properly shape, seal, and cut the material.

In aspects, each of the molding units 410 may enter the closed position and/or the open position simultaneously. For example, when one molding unit 410 enters the closed position (FIG. 4B), all other molding units 410 are similarly programmed to enter the closed position. In aspects, each of the molding units 410 may enter the closed position and/or the open position independently. For example, one molding unit 420 may enter the closed position (FIG. 4B) while another molding unit 410 remains in the open position (FIG. 4A), and vice versa. While three molding units 410 are shown in FIGS. 4A and 4B, any number of molding units 410 is contemplated.

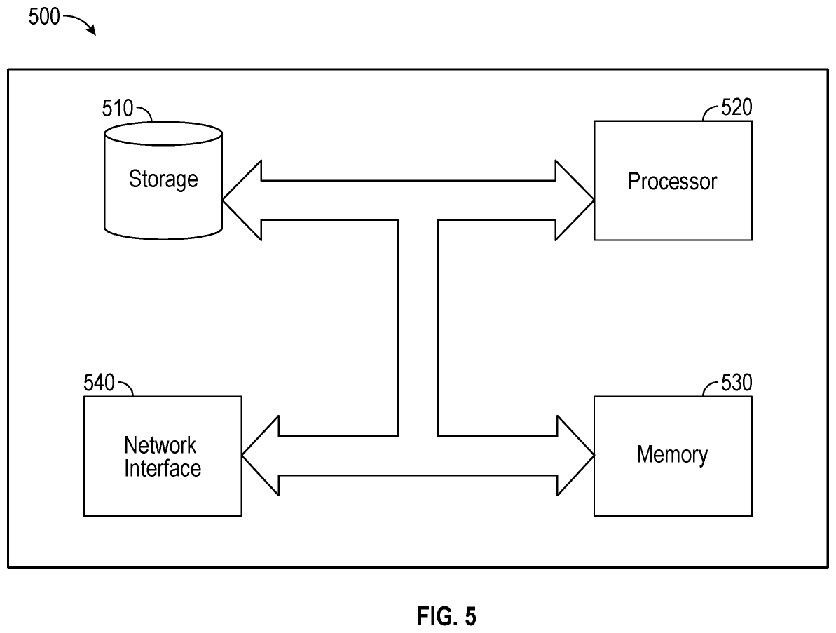

FIG. 5 illustrates controller 500, which includes processor 520 connected to a computer-readable storage medium or memory 530. The controller may be used to control and/or execute operation of the mass production system 400. Controller 500 may be electronically connected mass production system 400 by connection 505. The computer-readable storage medium or memory 530 may be a volatile type of memory, e.g., RAM, or a non-volatile type of memory, e.g., flash media, disk media, etc. In various aspects of the disclosure, the processor 520 may be another type of processor, such as a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 530 can be random access memory, read-only memory, magnetic disk memory, solid-state memory, optical disc memory, and/or another type of memory. In some aspects of the disclosure, the memory 530 can be separate from the controller 500 and can communicate with the processor 520 through communication buses of a circuit board and/or through communication cables such as serial ATA cables or other types of cables. Memory 530 includes computer-readable instructions that are executable by the processor 520 to operate the controller 500. In other aspects of the disclosure, the controller 500 may include a network interface 540 to communicate with other computers or to a server. A storage device 510 may be used for storing data. The disclosed method may run on the controller 500 or on a user device, including, for example, on a mobile device, an IoT device, or a server system.

Although mass production systems for food product 300 are used as an example, other large-scale systems are contemplated to be within the scope of this disclosure.

It should be understood that the foregoing description is only illustrative of the present disclosure. Various alternatives, modifications, and variances can be devised by those skilled in the art without departing from the disclosure. For instance, although certain aspects herein are described as separate aspects, each of the aspects herein may be combined with one or more of the other aspects herein. Specific structural and functional details disclosed herein are not to be interpreted as limiting but as a basis for the claims and as a representative basis for teaching one skilled in the art to variously employ the present disclosure in any appropriately detailed structure. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. An apparatus for producing a layered food product, the apparatus comprising:
a handle assembly configured to apply pressure to a plurality of food layers, the handle assembly including:
a rod configured for grasping by a user; and
a crossbar operably connected to the rod;
a body configured to move relative to the handle assembly, the body including:
an external surface including:
a plurality of external, upper walls tapering to an uppermost surface, the uppermost surface maintaining contact with the crossbar, wherein the plurality of external, upper walls connect to form a pyramid; and
a plurality of external, lower walls;
an internal surface including:
a plurality of internal, upper walls having a first lining configured to shape the plurality of food layers and a second lining configured to seal the plurality of food layers; and
a plurality of internal, lower walls terminating at a geometric edge, the geometric edge configured to cut the plurality of food layers in a shape corresponding to the geometric edge.

2. The apparatus of claim 1, wherein applying pressure to the handle assembly enables the body to:
shape the plurality of food layers into a pyramid;
seal the plurality of food layers; and
cut the plurality of food layers, producing the layered food product.

3. The apparatus of claim 2, wherein sealing the plurality of food layers includes sealing a filling inside of the layered food product.

4. The apparatus of claim 1, wherein the plurality of food layers include at least two layers of laminated dough.

5. The apparatus of claim 1, wherein at least one of the handle assembly and the body are fabricated from stainless steel.

6. The apparatus of claim 1, wherein the rod includes a grip.

7. The apparatus of claim 1, wherein the handle assembly is attached to the external, upper walls in a fixed manner.

8. The apparatus of claim 7, wherein the handle assembly is attached to the external, upper walls by at least one of welding, crimping, gluing, or fastening.

9. The apparatus of claim 1, wherein the plurality of external, lower walls each have a length ranging from about 8.5 centimeters to 10.5 centimeters.

10. The apparatus of claim 1, wherein the plurality of external, lower walls each have a height ranging from about 0.5 centimeters to 2.5 centimeters.

11. A system for producing a layered food product, the system comprising:
a frame configured to support the system, the frame including a plurality of vertical support shafts, a rod, and a base;
a plurality of molding units configured to apply pressure to a plurality of food layers, each of the plurality of molding units including:
an apparatus having a body including:
an external surface including:
a plurality of external, upper walls tapering at an uppermost surface, wherein the plurality of external, upper walls connect to form a pyramid; and
a plurality of external, lower walls;
an internal surface including:
a plurality of internal, upper walls having a first lining configured to shape the plurality of food layers, and a second lining configured to seal the plurality of food layers; and
a plurality of internal, lower walls terminating in a geometric edge, the geometric edge configured to cut the plurality of food layers in a shape corresponding to the geometric edge; and
a spring operably connected to the apparatus, the spring configured to move a molding unit of the plurality of molding units into an active position and a retracted position;
a plank operably connecting the spring to the apparatus, the plank configured to apply pressure to the apparatus;
a conveyor belt configured to transport the plurality of food layers and the layered food product; and
a collection bin configured to store the layered food product.

12. The system of claim 11, further comprising a controller including:
a processor; and
a memory having instructions stored thereon, wherein the instructions, when executed, cause the system to:
extend the spring along a downward plane;
apply pressure from the spring to the plank; and
apply pressure from the plank to the apparatus, causing the molding unit of the plurality of molding units to convert from the open position to the closed position.

13. The system of claim 12, wherein in the open position enables the apparatus to:
shape the plurality of food layers into a pyramid;
seal the plurality of food layers; and
cut the plurality of food layers, producing the layered food product.

14. The system of claim 13, wherein sealing the plurality of food layers includes sealing a filling inside of the layered food product.

15. The system of claim 11, wherein the plurality of food layers includes at least two layers of laminated dough.

16. The system of claim 11, wherein at least one of the frame, the plurality of molding units, and the plank are fabricated from stainless steel.

17. The system of claim 11, wherein the instructions further cause the system to:
convert the conveyor belt from an active state to a paused state,
wherein in the active state, the conveyor belt engages in motion at a predetermined speed, and wherein in the paused state, the conveyor belt ceases motion for a predetermined length of time.

18. The system of claim 17, wherein the predetermined speed is between about 2.5 centimeters to 7.6 centimeters per minute.

19. The system of claim 17, wherein the predetermined length of time is between about 2 to 4 minutes.

20. An apparatus for producing a layered food product, the apparatus comprising:
a handle assembly configured to apply pressure to a plurality of food layers, the handle assembly including:
a U-shaped rod configured for grasping by a user; and
a crossbar operably connected to the rod;
a body configured to move relative to the handle assembly, the body including:
an external surface including:
a plurality of external, upper walls tapering at a peak, the peak maintaining contact with the crossbar, wherein the plurality of external, upper walls connect to form a pyramid; and
a plurality of external, lower walls forming sloped sides;
an internal surface including:
a plurality of internal, upper walls having a first lining configured to shape the plurality of food layers and a second lining configured to seal the plurality of food layers; and
a plurality of internal, lower walls terminating at a square edge, the square edge configured to cut the plurality of food layers in a shape corresponding to the geometric edge,
wherein applying pressure to the handle assembly enables the body to:
shape the plurality of food layers into a pyramid;
seal the plurality of food layers; and
cut the plurality of food layers, producing the layered food product.
